(19) United States
(12) Patent Application Publication
(10) Pub. No.: US 2002/0178180 A1
(43) Pub. Date: Nov. 28, 2002

(54) Document usage monitoring method and system

(76) Inventors: Tanya Kolosova, Coquitlam (CA); Samuel Berestizhevsky, Coquitlam (CA)

Correspondence Address: PEPPER HAMILTON LLP, 50th Floor, One Mellon Center, 500 Grant Street, Pittsburgh, PA, 15219, US

(21) Appl. No.: 10/151,561

(22) Filed: May 21, 2002

Related U.S. Application Data
(60) Provisional application No. 60/292,776, filed on May 22, 2001.

(51) Int. Cl. G06F 15/00; G06F 17/24; G06F 17/21

(52) U.S. Cl. 707/500

(57) ABSTRACT

A document that is accessible by a first computing apparatus via a global communication network, such as a web page, includes a tag that is operative to receive information corresponding to a user of the document and delivering the information to a second computing apparatus via a global communications network. The information may include user identification information and/or user activity information. Optionally, the collected information may be stored in a database. A report of document usage may also be created, wherein the report includes information such as an identification of a document and an analysis of a number of users of the document during a time period or a point in time, or a predicted usage in the future based on past results.

### CLAIM OF PRIORITY

This application claims priority to the co-pending United States Provisional Patent Application entitled “Document Usage Monitoring Method and System,” filed May 22, 2001, having a Ser. No. of 60/292,776, and which is incorporated herein by reference in its entirety.

### FIELD OF THE INVENTION

The present invention relates generally to the collection, storing, analysis and presentation of information about Internet-based activities. More particularly, the present invention relates to a method and system for monitoring usage of documents such as pages on a global communication network such as the Internet.

### BACKGROUND OF THE INVENTION

the Internet has become a part of everyday life, the importance of the Internet to commerce has significantly increased. Businesses in almost every industry and commercial sector seek to have a presence on the Internet whether by maintaining their own web sites or by advertising on other web sites. Because of the large number of web sites that are available, web site owners and Internet advertisers seek a reliable method of determining the effectiveness of their advertising, as well as a method of determining which web sites have the potential to reach the greatest number of prospective customers.

One way of monitoring web document usage or measuring the effectiveness of an advertisement on the Internet is with a “hit counter.” A hit counter is a software program that is resident on the server that hosts the web site. A hit counter measures the number of times that Internet users access a web document by visiting a page on the web site. Typically, hit counters measure the number of times that users visit the home page of a web site. The results of the hit counter provide web site owners and Internet advertisers with data relating to the number of users that visit a web site or who access a web document.

The prior art hit counters exhibit several disadvantages to measure the effectiveness of a web site or advertising. Although prior art hit counters are designed to measure the number of times that users access a web document on the host server, web documents may also be stored on servers other than the host server. Such proxy servers may include any individual computer or network of computers that stores one or more pages of a web site for browsing by a user at a later time. The prior art hit counters are not capable of identifying the number of users that access a web document when the web document is stored on a proxy server. Thus, the prior art hit counters do not provide accurate usage data. This inaccuracy is a particular problem for popular web sites, as such web sites are more likely to be stored on a greater number of proxy servers. Another disadvantage is that “hit counters” influence loading of monitored documents, as the processing time associated with a hit counter reduces the speed of loading a document. Also, the log file structure of a hit counter is time consuming for read access, thus on-line data retrieving and analysis is slow.

Accordingly, it is desirable to provide an improved method and system for monitoring usage of documents that are accessible via a communications network.

### SUMMARY OF THE INVENTION

The invention comprises a novel document usage monitoring method and system as herein disclosed. In accordance with one embodiment of the invention, a method of monitoring user activities related to at least one document includes maintaining a document that is accessible via a communication network. The document includes a tag. The method also includes receiving information corresponding to a user of the document and delivering the information to a computing apparatus. Optionally, the delivering is implemented via the global communication network such as the Internet. Also optionally, the method may include the additional step of storing the identifying information in a database. The database may correspond to the computing apparatus, and the document may correspond to a second computing apparatus, wherein each computing apparatus is in communication with the other via the global communication network. The tag may be a computer program, and the information may include identifying information such as an address, a name, a host, or a code, or usage information such as document downloading and banner or link access. Optionally, the method includes the additional steps of creating a report of document usage, wherein the report comprises an identification of the documents and a total number of users of the document during a time period. The method may also optionally include the additional step of creating a report of document usage, wherein the report includes an identification of the document and one or more of several types of summarizations and analyses of users of the document at a point in time, or in a time period.

In accordance with another embodiment of the present invention, a method of monitoring usage of a web document comprises maintaining a web document having a document identifier, receiving information relating to a user of the web document, communicating the information and the document identifier to a first computing apparatus, and recording in a database contained within the computing apparatus' memory the identifying information and the document identifier. The communicating is performed via a global communications network such as the Internet. The document may correspond to a second computing apparatus, and the identifying information may include information such as an address, a name, a host, or a code. The method may optionally include the additional step of creating a report of usage of the web document, wherein the report comprises the document identifier and the identifying information relating to at least one user. The method may also optionally include an additional step of creating a report of document usage, wherein the report comprises the document identifier and one or more of several types of summarizations and analyses of users of the web document at a point in time, or in a time period.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract set forth below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flowchart that illustrates the process flow of a preferred embodiment of the present inventive method.

FIG. 2 is a block diagram that illustrates the interrelation of various elements of a preferred embodiment of the present inventive system.

FIG. 3 is a chart that illustrates exemplary types of information that may be collected by the present inventive method and system.

FIG. 4 is a block diagram that illustrates a preferred embodiment the data storing feature of the present invention.

FIG. 5 illustrates an exemplary process flow that implements the data restoration feature.

FIG. 6 is a block diagram of one embodiment of a data compression feature that may be included in the present invention.

FIG. 7 is a block diagram that illustrates examples of the types of real-time reports that may be created through real-time data analysis by the present invention.

FIG. 8 is a block diagram that illustrates examples of the type of reports that may be created be the present invention based on data that is collected over a period of time, such as a week.

FIGS. 9A and 9B are flowcharts that illustrate the statistical analysis that may be performed by the present invention to create a report.

FIG. 10 is a flowchart that illustrates the exemplary steps that may be followed to create a model predicting document usage over a period of time.

FIG. 11 is a flowchart of the steps that may be taken to analyze and create reports that divide groups of visitors into clusters according to their information needs.

FIGS. 12-16 illustrate examples of several types of reports that may be created by the present inventive method and system, along with exemplary information that may be contained within each such report.

FIG. 17 is a block diagram that illustrates a computer of a type suitable for carrying out and/or comprising the system of the invention.

FIG. 18 is a block diagram of the internal hardware of the computer of FIG. 17.

FIG. 19 illustrates an exemplary computer-readable carrier.

### DETAILED DESCRIPTION OF THE INVENTION

The present invention provides a unique document usage monitoring and statistical reporting system that helps Internet users, web site developers, web site owners, and Internet advertisers determine the effectiveness or popularity a web site, regardless of the location of the site or documents. The invention is capable of real-time monitoring and statistical reporting and reliable measurement of the popularity of a web site, including pages within the web site, thus providing valuable marketing information. The invention may also monitor files that are downloaded from a web site and generate statistical reports in real time providing information about site access and file downloading. The invention builds and maintains a historical utilization and performance data base for a web site or web document and may automatically classify web site users who demonstrate similar information needs.

The present inventive method is a server-based method intended to monitor and report on activities on different types of documents that are accessible via a global communications network such as the Internet, including for example World Wide Web documents. A host server contains programs necessary to correct, store, analyze and present the information, regardless of the location of the users server or the web document. The web document for which analysis and monitoring is desired includes a tag such as a hypertext markup language (“HTML”) tag. The tag contains instructions that provide the host server with information relating to the user's activities relating to the web site or document. In addition to HTML, tags may be provided in Java script, XML, or any other language or platform that facilitates communication via a global communications network.

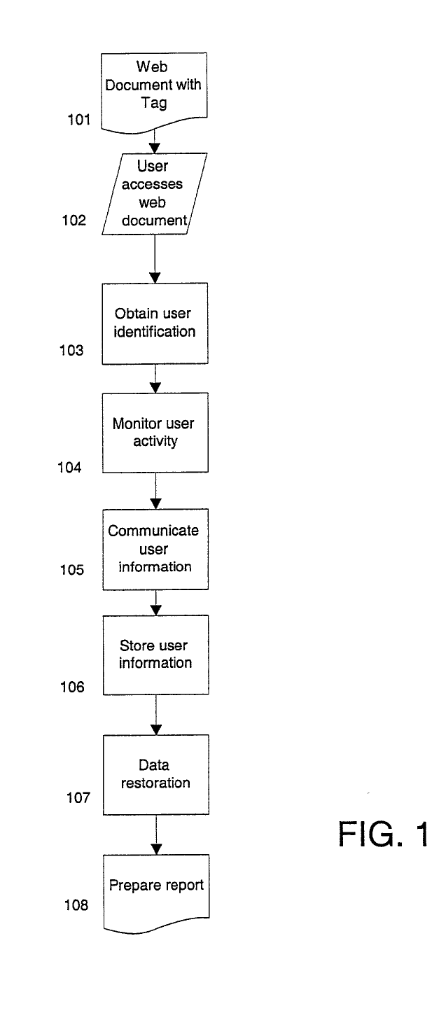

A preferred embodiment of the present inventive method is illustrated in FIG. 1. Referring to FIG. 1, when a monitored web document 101 is accessed 102 by a user by being loaded into a visitor browser or clicked on by a visitor. A tag in the document initiates a corresponding program on the host server that captures 103 information, such as identification information, about the visitor who accessed the web document. The same tag or different tags may collect information relating to user activity 104 such as file downloads, banner links, and other actions. The captured information is communicated 105 to the host server, which captures and stores information 106. Optionally, the host server also generates a report 108 that presents the monitoring results. If, while generating a report, the method encounters a damaged record, the data may be excluded 107 from the report through the use of a data restoration algorithm.

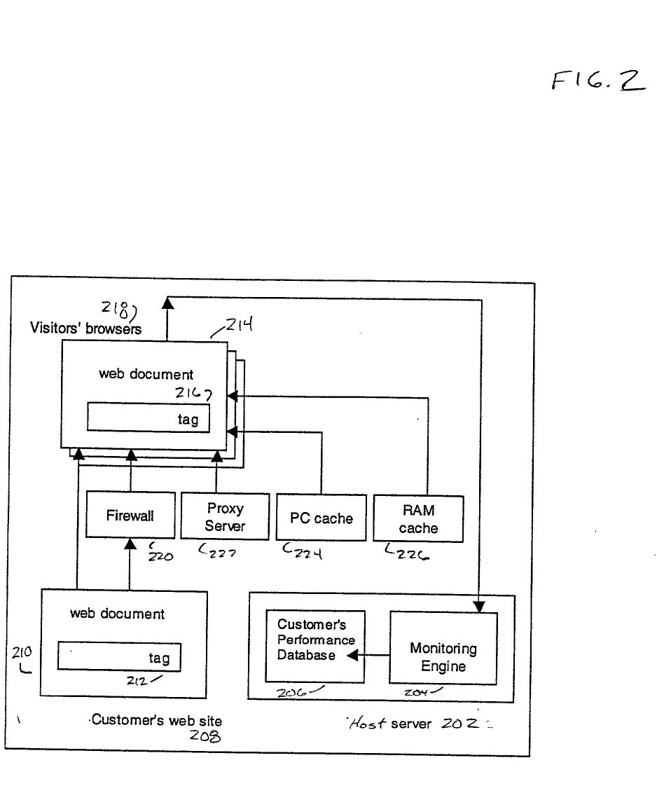

FIG. 2 illustrates several features of a preferred embodiment of the present inventive system. A host server 202 hosts a monitoring engine 204 that receives user identification and activity data. The host server also includes a performance database 206 that stores the information received by the monitoring engine 204. A customer web site 208 includes one or more web documents 210. Each web document for which monitoring is desired includes one or more tags 212. A visitor may view the web document 210, or the visitor may view an instance of the document 214 by loading the web document into the visitor's browser 218. The loaded instance of the web document 214 will also include an instance of the tag 216. When the document 214 and tag 216 are loaded into the browser 218, the tag provides the monitoring engine 204 with information corresponding to the visitor. Optionally, the user may access the web document directly from the customer web site 208, through a firewall 220 to the customer web site 208, or from a separate proxy server 222 that contains an instance of the web document. The visitor may also access instances of the web document that are stored in the visitors PC cache 224 or RAM cache 226, or any other location on which an instance of the web document 214 is stored.

Several types of tags may be used in connection with the present invention. For example, a regular tag may be used for monitoring static and dynamically created web documents. Such a tag would be compatible with most or all existing browsers and standard web server configurations. A different type of tag may be used on pages located on specific types of web servers, such as web servers enabled with Server Side Includes (“SSI”). Such a tag could obtain more detailed information about the visitor. A second alternate tag may be implemented in an alternate language or platform, such as Java script. A separate tag may be used to link to a file for downloading, thus monitoring the downloading of files from a web site by visitors. Additionally, a different tag may be used to monitor user selection of external and internal links on a web site.

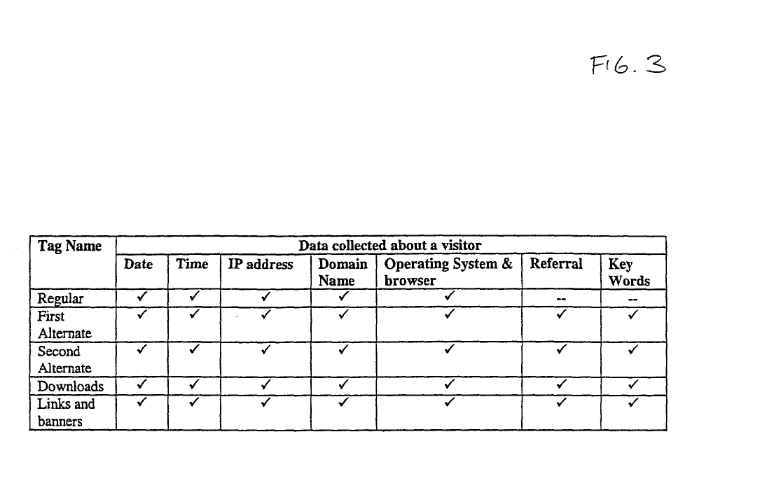

The data collected by the monitoring engine may vary based on the type of tag. One example of the types of data that may be collected by the above-referenced exemplary tags is illustrated in FIG. 3. For example, the data collected may include the date that the visitor accesses a document or downloads a file, the time of such activity, an internet protocol (“IP”) address of the visitor, the domain name from which the visitor visits the web document, the visitor's operating system and/or browser type, and /or other information such as referral data or key words entered by the user.

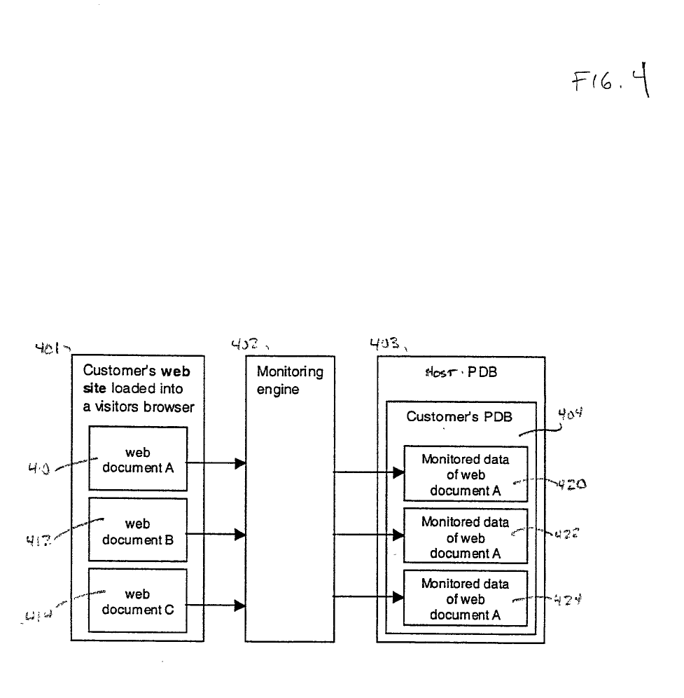

Data collected by the present inventive method and system may be stored on the host server in one or more performance databases (“PDBs”). Optionally, data relating to each web site or web document that is to be monitored may be stored in a separate PDB. FIG. 4 illustrates an exemplary embodiment of the optional data storing mechanism. In this embodiment, the host server includes a separate customer PDB 404 corresponding to each web site 401 for which usage monitoring is desired. Data relating to each web document 410, 412, and 414 is included within the customer web site 401 is collected by the monitoring engine 402 and delivered to the host server 403, where it is stored in the customer PDB 404. Data relating to each individual web document related to the same customer web site is optionally and preferably stored in separate files 420, 422, and 424 located within the database 404 in this exemplary embodiment.

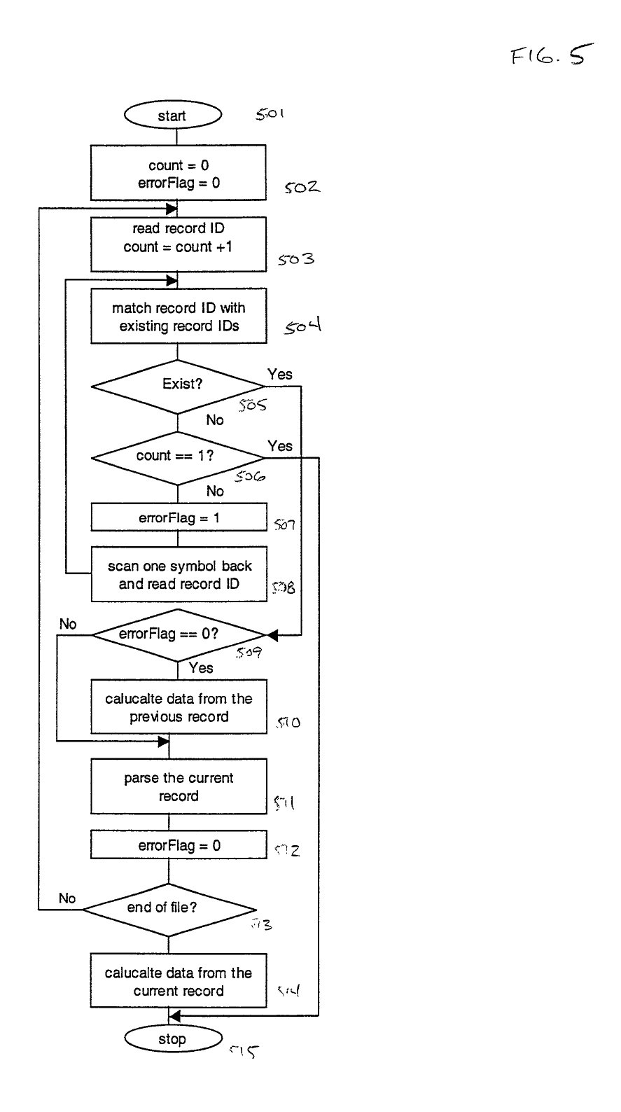

Sometimes data transferred over the Internet may be damaged. The invention optionally and preferably includes a data restoration feature that protects the reports from the influence of damaged data stored within the PDB. FIG. 5 illustrates the steps that may be taken to implement the data restoration feature. Each record stored in the PDB includes a record ID. The record ID field is generated by the monitoring engine, while the values of other fields are received via the global communication network. If the data record is damaged, the data is not used in the calculation of statistics or data presentation.

FIG. 5 illustrates an exemplary process flow that implements the data restoration feature. At the beginning of the process, a “count” field and an “error flag” field are set 502 at zero. The system retrieves a record from the PDB and reads the record ID, increasing the count number by one 503. The system determines whether the record ID matches with an existing record ID 504. If the record ID does not match with an existing record ID, but the count is equal to one after step 503, the system stops 515 and does not use the record in the calculation. If the record ID does not match an existing record ID but the count is not equal to one, the system sets the error flag to a one value 507 and returns to the step wherein it reads a record ID 508 again, at which time the matching process is repeated. If the record ID matches with an existing record ID, the system determines whether the error flag had been set. If the error flag had not been set to anything other than zero, the system calculates data from the previous record 510. Otherwise, the system parses the current record 511, sets the error flag to zero 512, determines whether the file has ended 513, and calculates data from the current record 514.

Optionally, a user may desire that the present invention store monitored data for a significant period of time. Because the storage medium volume associated with storing a large quantity of data can be large, a preferred embodiment of the present invention may include a data compression feature. When implemented, the data compression feature includes a special data structure and special data compression algorithm.

The special data structure was developed that enables, from the one hand, to store summarized data, and from the other hand, to re-summarize this data along with recently collected raw data. The size of a file of this data structure can be calculated ahead and does not depend on the amount of collected data. Thus, preferably the size of such a file is approximately constant, and does not grow as the amount of data grows.

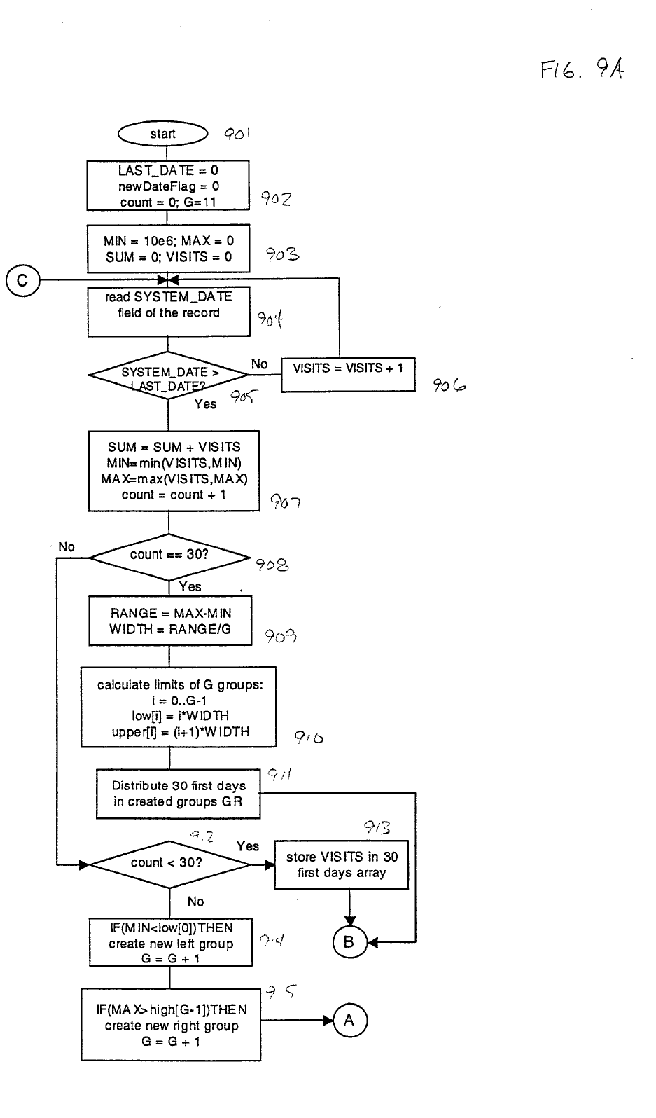

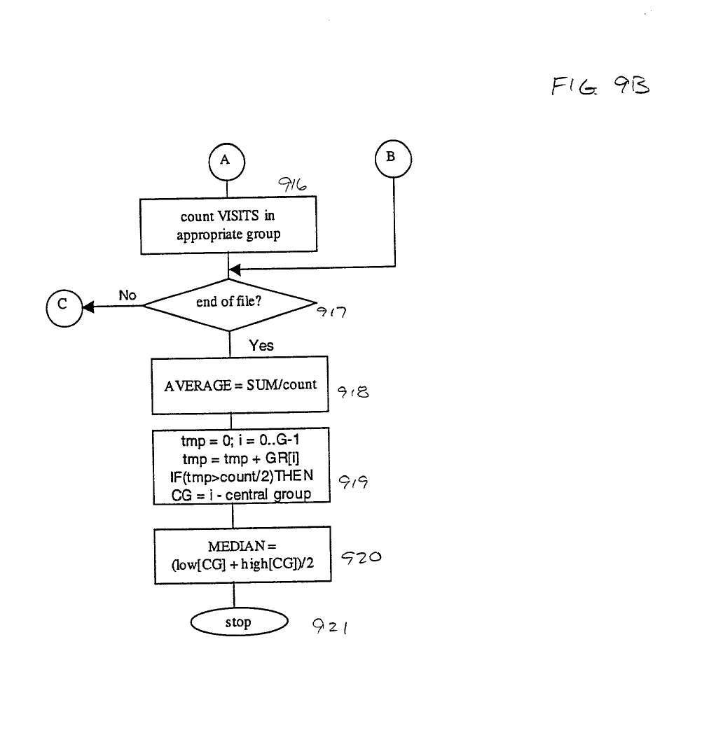

The optional special data compression algorithm enables the method and system to summarize collected data and/or re-summarize previously summarized data along with recently collected data. This algorithm includes, for example, recursive computation of descriptive statistics like average, median, standard deviation, etc. The algorithm begins by creating a flag file which plays a semaphore role for “discovering” programs. The “discovering” programs wait in standby status while the Flag file exists. Next, existing compressed statistics are copied to the temporary statistics (TS) file, and the monitor file is renamed as a temporary monitor (TM) file. From this moment, the monitor file will create the new file. The system then recalculates the statistics and creates a new compressed statistics file, first by reading a record from the TM file and then by storing the TM file pointer. Then, the same page name is found in the stored Pages list section. If there is no such page, memory is allocated for the new page and the TM file pointer is stored. Starting from the current TM file pointer up to the end of the TM file, the system reads record by record while the recursive computation algorithm (described in FIGS. 9A and 9B) is performed. Recalculated statistics are written, and the new compressed statistics file is copied to the compressed statistics file. Finally, the system deletes the Flag file and the TS and TM files.

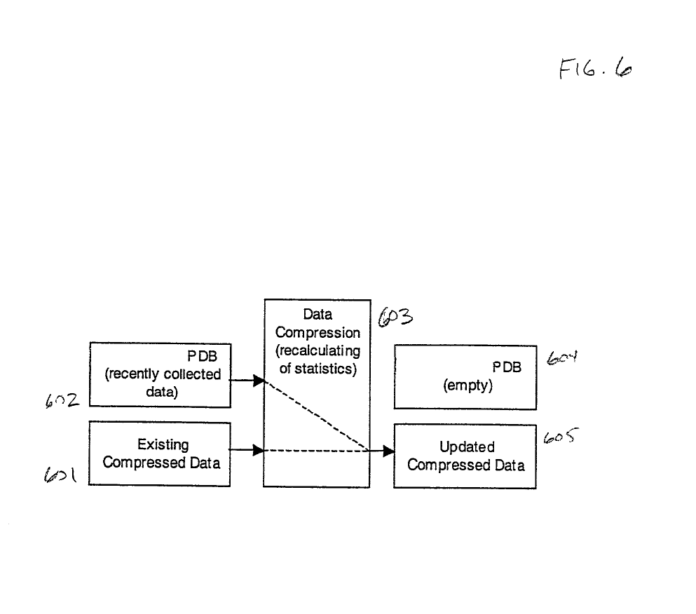

FIG. 6 illustrates the exemplary elements of such a data compression feature. Referring to FIG. 6, compressed data 601 is compared to recently collected data 602 that is stored in the PDB. The compressed data file contains intermediate statistics that enable recursive recalculating 603 of statistics based on a comparison of the compressed data 601 to the new collected data 602. The process then returns updated compressed data 605 that may be used and analyzed by a user.

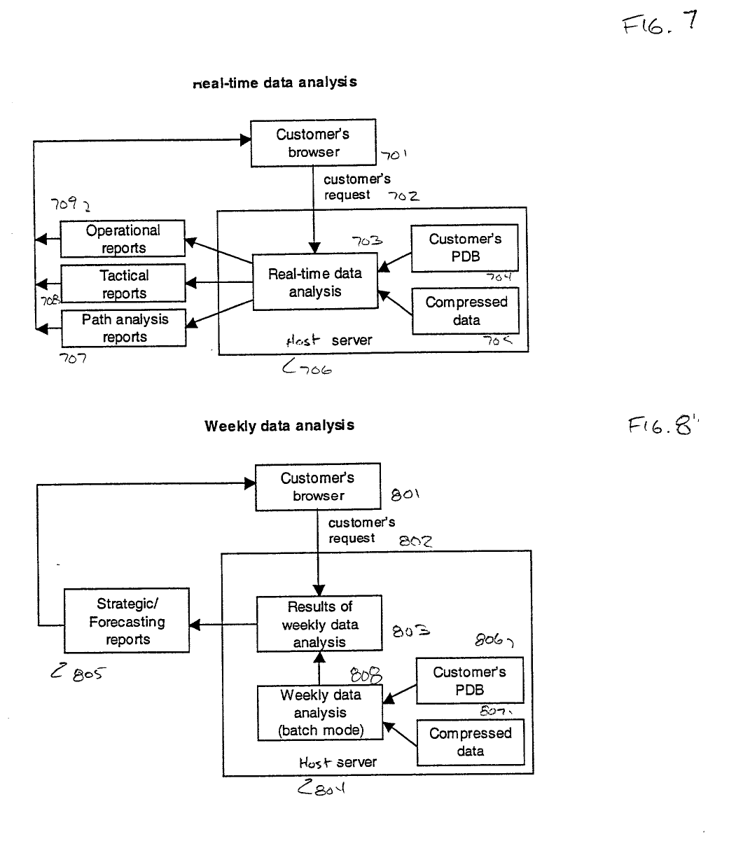

FIGS. 7 and 8 illustrate the preferred methods in which optional portions of the present invention information may transform collected data into information or reports that are meaningful to the user. FIG. 7 illustrates the types of reports that may be created through real-time data analysis, while FIG. 8 illustrates the type of reports that may be created based on data that is collected over a period of time, such as a week. The time period associated with a report is not limited to a week, and may in fact be a day, a month, a year, or any time period. Referring to FIG. 7, for real-time data analysis, in response to a customer request 702 the host server 706 may retrieve usage information from the customer's PDB 704. The server 706 may also optionally retrieve compressed data 705 from storage. The customer PDB information 704 and/or compressed data 705 are analyzed 703 to provide reports such as operational reports 709, technical reports 708, and path analysis reports 707. Such reports may include information such as the total number of visits per web document on an instantaneous basis, or over a brief period of time such as the present day or the present day plus the previous day. The report may also include, for example, a number of visits in different time frames such as doing an individual hour, or an individual day. The report could also provide a calculation of the number of visitors who access a document from different domains or different referrals, as well as the path analysis of the visitor within the site showing the steps that the visitor took to reach the document. The report could also include a list of any number of key words, such as fifty key words, that were used to find the web document or other descriptive statistics within a specified period of time. The report could also optionally include information such as minimum, average, median, and maximum number of visits per day. In addition, referring to FIG. 8, the system and method may perform an analysis over a period of time such as a week in a mode such as a batch mode 808, and the report is then presented to a customer in response to the customer's request 802.

FIGS. 9A and 9B illustrate the process flow of an exemplary embodiment of the analysis that is performed for report preparation. Optionally, the present invention may provide users with models that help predict document usage over repeated periods of time, such as days, weeks, or months. The models are developed by summarizing the information collected during user visits that occur within a period of time and analyzing that information over a modeling period. The report preparation algorithm begins by performing one pass calculation of descriptive statistics using data from the compressed statistics file and monitor file 901. The local variables are then initialized 902, 903, and if the compressed statistics file already exists, its statistics are preferably used for initialization. Next, the number of visits during a time period, in this example one day, is counted 904, 905, 906, and the sum, minimum and maximum statistics are updated 907. If there are less than thirty days (or some other pre-established period) with visits 912, the number of visits is stored and the average and median are calculated 918, 919, 920, 921. If there are at least thirty days (or another preestablished amount) with visits 908, calculation of a histogram is performed. The number of groups at the beginning is eleven in this example. The width and the limits of these groups are calculated 909, 910, and each day starting from the 31^{st} is distributed into these groups 911. If the number of visits in any day starting from the 31^{st} is smaller than the lower limit or higher than the upper limit, then new groups may be created 914, 915, 916. When the end of the file is reached 917, the average 918 and the median 919 are calculated.

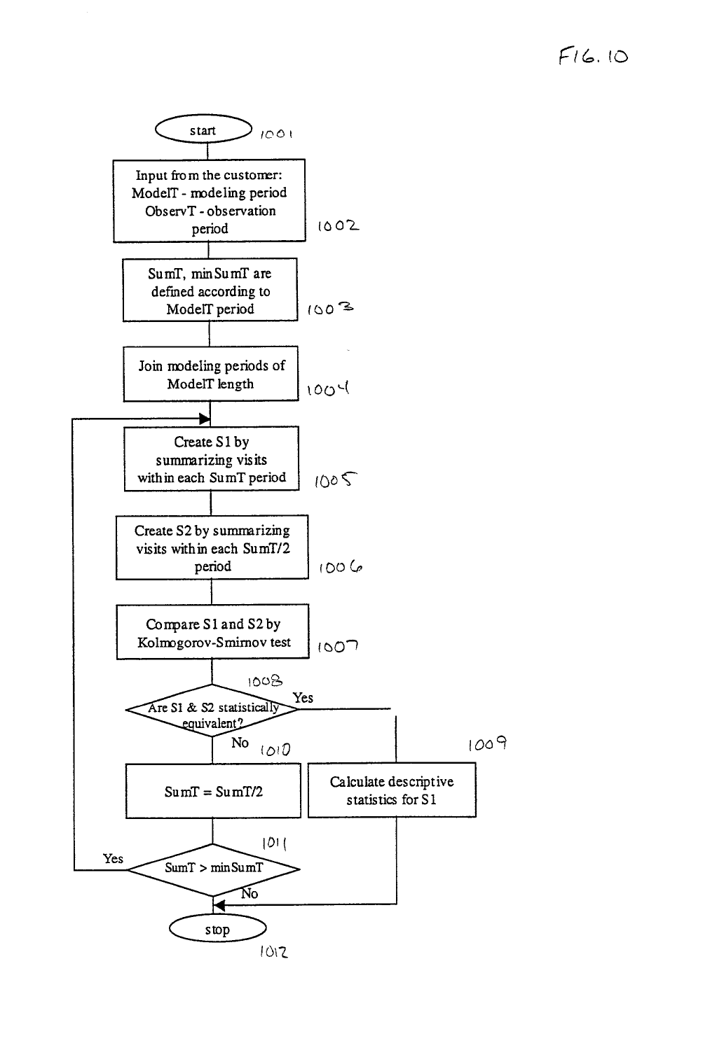

FIG. 10 illustrates the exemplary steps that may be followed to create such a model. Referring to FIG. 10, in step 1002, the customer defines a modeling period, which is the period of time for which he or she desires to build a model. The modeling period could be any period, such as a day, week, business week, month, or any other repeated period of time. In step 1002, the customer also defines an observation period, which is the period of time over which data gathered by the present invention should be used within the model. In step 1003, the longest and shortest possible summarization sub-periods within the monitoring period are defined. For example, if the modeling period is a week, the longest summarization period may be, for example, a day, the shortest possible summarization sub-period may be, for example, an hour. In step 1004, the data gathered by the present invention within an observation period are divided into modeling periods, and joined together so that a new time series of data having a time period equal to the modeling period is created. In step 1005, based on the recently created time series, the number of visits during the current summarization period is calculated. In step 1006, a subcalculation of the number of visits during each half of the current summarization period is calculated and subsequently, in step 1007, the two models created in steps 1005 and 1006 are compared using an analysis for statistical equivalency or goodness of fit, such as the Kolmogorov-Smirnov test. If the models are statistically equivalent or substantially statistically equivalent 1008, the current summarization period is considered as a meaningful time frame 1010, and the model received in step 1005 is considered as the model for the modeling period. Otherwise, the new current summarization period is taken as half of the previous one in step 1011, and steps 1005-1007 are repeated.

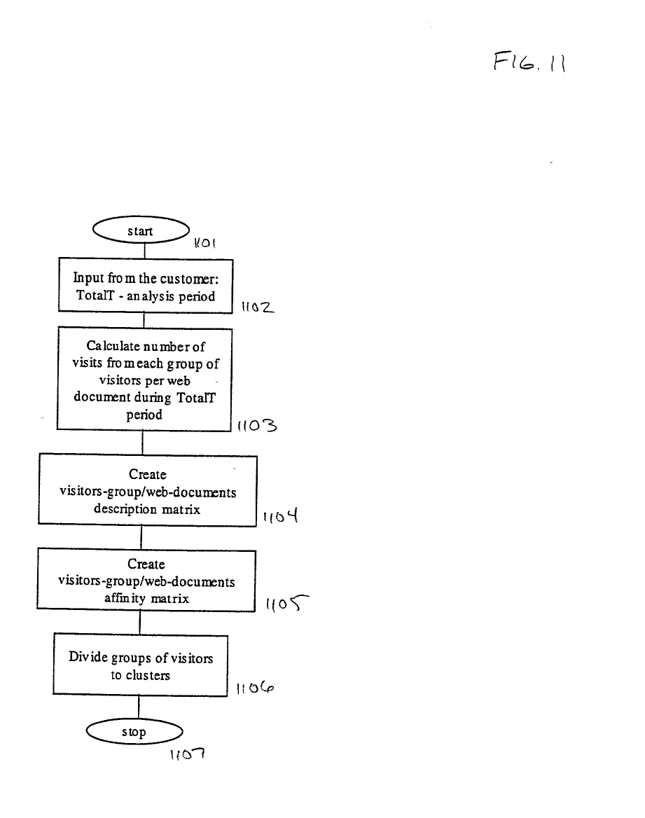

Another optional feature of the present invention is the ability to analyze and create reports that divide groups of visitors into clusters according to their information needs. FIG. 11 describes exemplary steps that may be taken to perform such an analysis. In step 1102, the customer may define an analysis period, or the analysis period may be predefined. The system then defines a group of visitors, either by domain name, Internet Protocol (IP) address, portion of IP address, set of IP addresses, set of domain names, or other common aspects. In step 1103, the system calculates the number of visits from each group of visitors per web document during the analysis period. The calculations may be reported to the user in a description matrix 1104 that describes the number of each group of visitors to each monitored web document, or in an affinity matrix 1105, which identifies the propensity of particular groups of users to use particular documents. The groups may then be divided into clusters 1106 responding to affinity or usage description by some of existing clusterization algorithm.

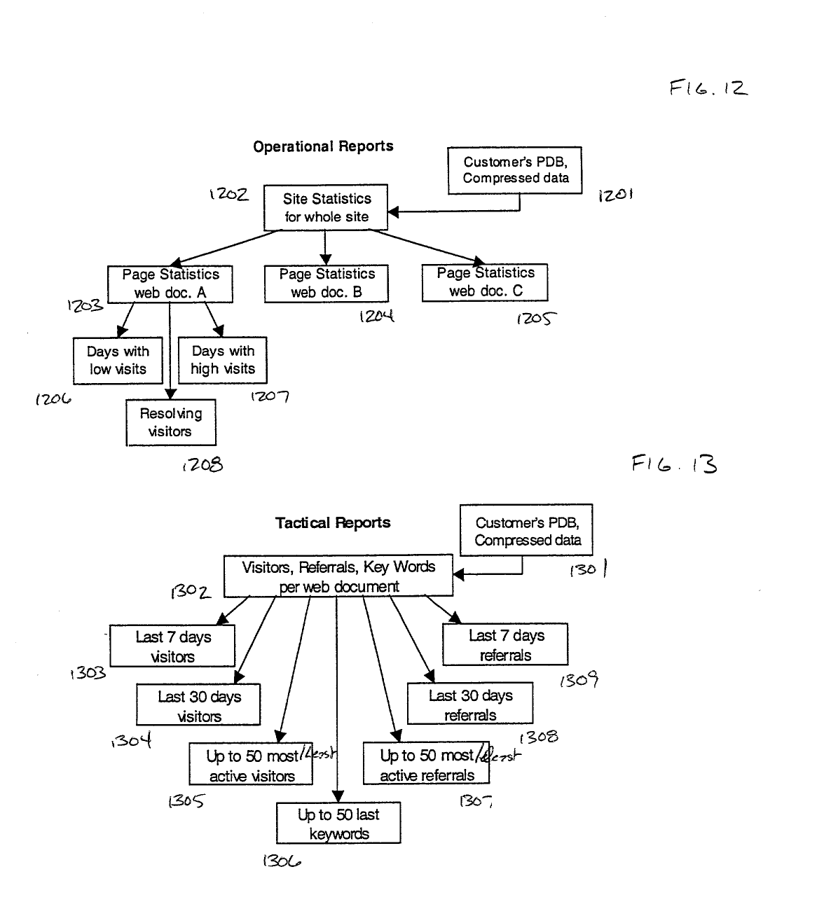

FIGS. 12-16 illustrate examples of several types of reports, and information contained within such reports, that may be created by the present inventive method and system.

Referring to FIG. 12, based on information reflected and stored in a customer's PDB 1201, a report may include statistics relating to a customer's entire web site 1202, or statistics relating to an individual page within the web site 1203, 1204 and/or 1205. Such statistics may include information such as days with low visits, days with high visits, and/or resolving visitors.

Referring to FIG. 13, tactical reports may include information such as the number of referrals from a website within a time period 1308 or 1309, the most active or least active visitors or referrals 1305 or 1307, and/or the key words that have been used to access the document 1306.

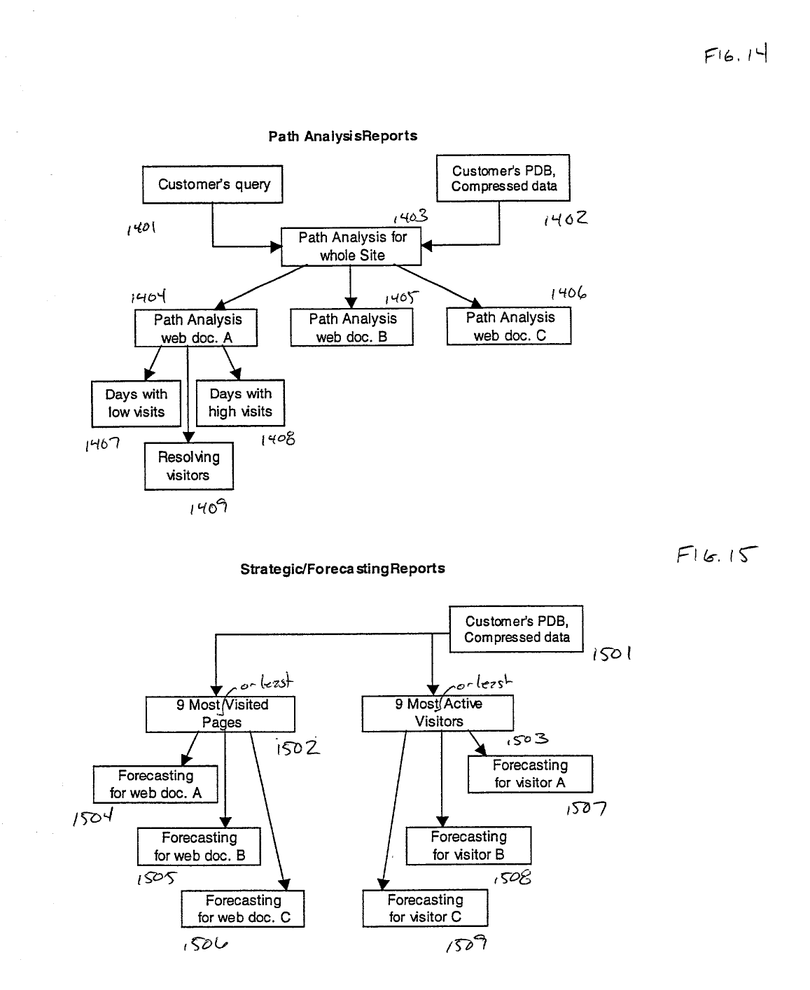

Referring to FIG. 14, path analysis reports may, preferably in response to a customer inquiry, provide information such as dates with low or high numbers of visits 1407 or 1408 and resolving visitors for the whole site and/or a web document within the site 1409.

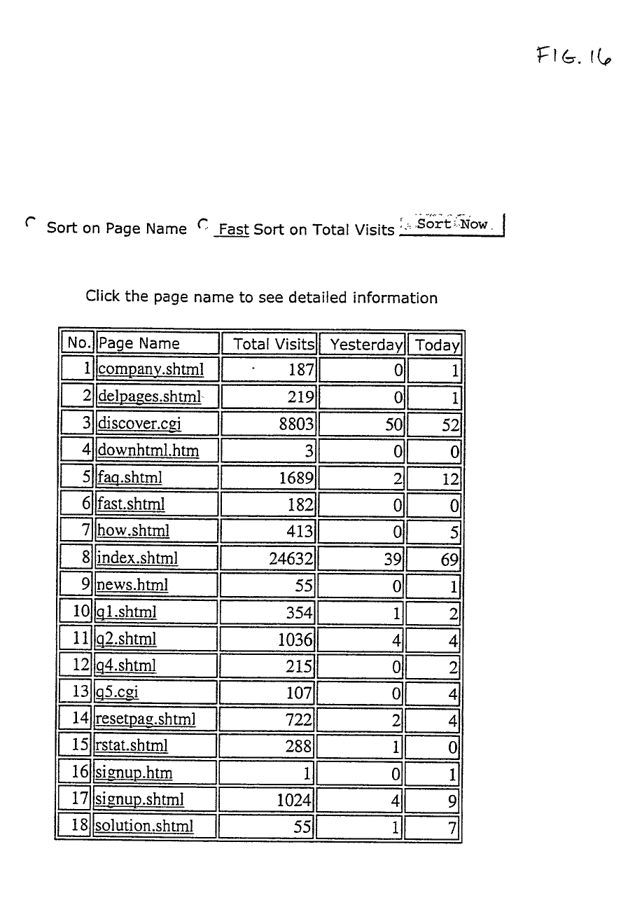

Referring to FIG. 15, strategic or forecasting reports may, based on previous information or currently-collected information, provide analyses such as the most or least visited pages within a site 1502, or the most or least active visitors within a site 1503 Such reports may also provide forecasts of predicted future usage of documents 1504, 1505, or 1506, or predicted future activity by one or more specific visitors 1507, 1508 or 1509.

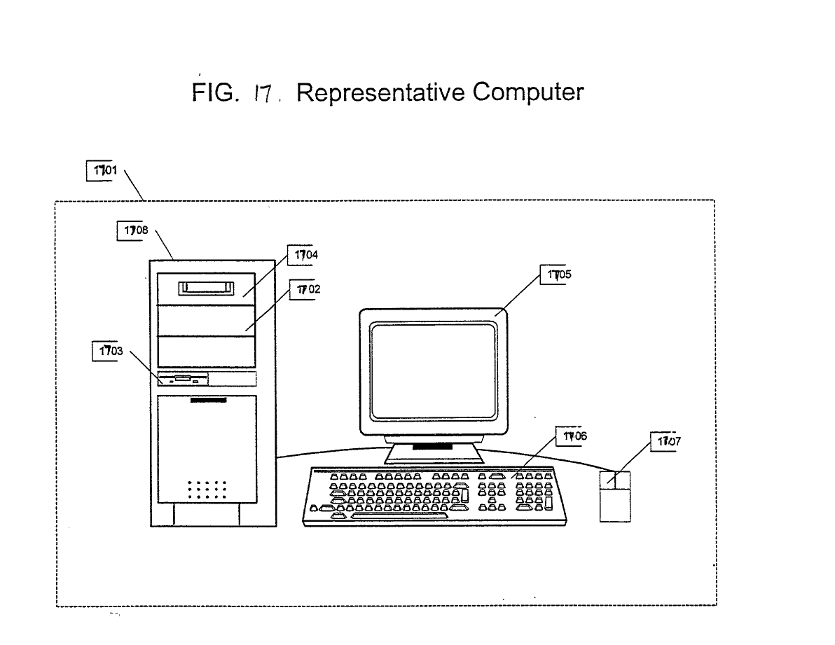

FIG. 16 illustrates an exemplary web-based report of the total number of visits to various pages of a website within three exemplary time periods.

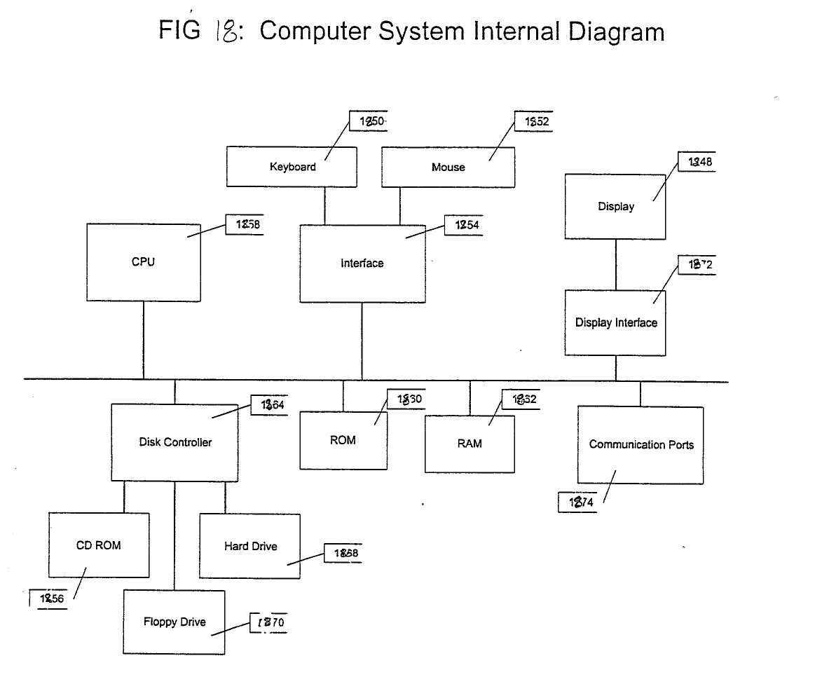

FIG. 17 illustrates a computer of a type suitable for carrying out and/or comprising the system of the invention. Viewed externally in FIG. 17, a computer system designated by reference numeral 1701 has a central processing unit located within a housing 1708 and one or more disk drives such as 1703 and 1704. Disk drives 1703 and 1704 are merely symbolic of a number of disk drives which might be accommodated by the computer system. Typically these would include a hard disk drive and optionally one or more floppy disk drives such as 1703 and/or one or more CD-ROMs, CD-Rs, CD-RWs or digital video disk (DVD) devices indicated by slot 1704. The number and types of drives typically varies with different computer configurations. Disk drives 1703 and 1704 are in fact options, and they may be omitted from the computer system used in connection with the processes described herein. Additionally, the computer system utilized for implementing the present invention may be a stand-alone computer having communications capability, a computer connected to a network or able to communicate via a network, a handheld computing device, or any other form of computing device capable of carrying out equivalent operations.

The computer also has or is connected to or delivers signals to a display 1705 upon which graphical, video and/or alphanumeric information is displayed. The display may be any device capable of presenting visual images, such as a television screen, a computer monitor, a projection device, a handheld or other microelectronic device having video display capabilities, or even a device such as a headset or helmet worn by the user to present visual images to the user's eyes. The computer may also have or be connected to other means of obtaining signals to be processed. Such means of obtaining these signals may include any device capable of receiving images and image streams, such as video input and graphics cards, digital signal processing units, appropriately configured network connections, or any other microelectronic device having such input capabilities.

An optional keyboard 1706 and./or a directing device 1707 such as a remote control, mouse, joystick, touch pad, track ball, steering wheel, remote control or any other type of pointing or directing device may be provided as input devices to interface with the central processing unit.

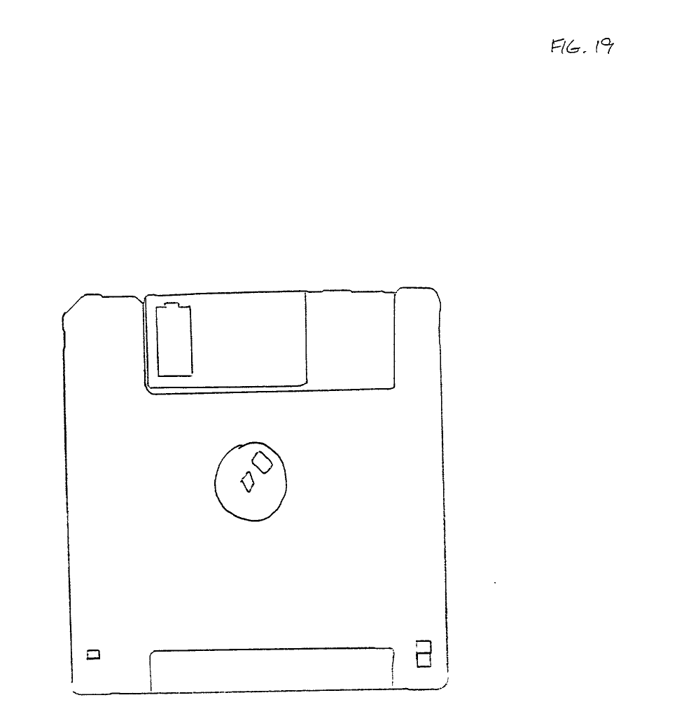

FIG. 18 illustrates a block diagram of the internal hardware of the computer of FIG. 17. A bus 1856 serves as the main information highway interconnecting the other components of the computer. CPU 1858 is the central processing unit of the system, performing calculations and logic operations required to execute a program. Read only memory (ROM) 1860 and random access memory (RAM) 1862 constitute the main memory of the computer.

A disk controller 1864 interfaces one or more disk drives to the system bus 1856. These disk drives may be external or internal floppy disk drives such as 1870, external or internal CD-ROM, CD-R, CD-RW or DVD drives such as 1866, or external or internal hard drives 1868. As indicated previously, these various disk drives and disk controllers are optional devices.

Program instructions may be stored in the ROM 1860 and/or the RAM 1862. Optionally, program instructions may be stored on a computer readable carrier such as a floppy disk (as illustrated in FIG. 19) or a digital disk or other recording medium, flash memory, a communications signal, or a carrier wave.

Returning to FIG. 18, a display interface 1872 permits information from the bus 1856 to be displayed on the display 1848 in audio, graphic or alphanumeric format. Communication with external devices may optionally occur using various communication ports such as 1874.

In addition to the standard components of the computer, the computer also includes an interface 1854 which allows for data input through the keyboard 1850 or other input device and/or the directional or pointing device 1852 such as a remote control, pointer, mouse or joystick.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described. Accordingly, all suitable modifications and equivalents may be resorted to, falling within the scope of the invention.

The invention claimed is:

1. A method of monitoring user activities corresponding to at least one document that is accessible via a communication network, comprising:
maintaining, on a first computing apparatus, a document that is accessible via a global communication network, the document including at least one tag;
receiving information corresponding to a user of the document; and
delivering the information to a second computing apparatus.

2. The method of claim 1, wherein the delivering step is implemented via the communication network.

3. The method of claim 1, comprising the additional step of storing the identifying information in at least one database.

4. The method of claim 1, wherein the at least one tag corresponds to a rule that initiates the receiving step or the delivering step.

5. The method of claim 1 wherein the information comprises an address, a name, a host, or a code.

6. The method of claim 1, comprising the additional step of creating a report that comprises an identification of the document and at least one of user information, an analysis of a number of users of the document at a point in time or during a time period, a number of days with low or high visits, a number of active users, a number of inactive users, and forecasting.

7. The method of claim 6, wherein the report creating step also comprises excluding from the report user information if the user information is damaged.

8. The method of claim 6, wherein the time period is an instantaneous point in time.

9. The method of claim 6, wherein the user information includes compressed user information and non-compressed user information, and comprising the additional step of comparing the compressed user information with the non-compressed user information and processing the compressed user information to yield additional non-compressed user information.

10. A method of monitoring usage of a web document, comprising
maintaining a web document having a tag and a document identifier;
receiving information relating to a user of the web document;
communicating the information relating to the user and the document identifier to a first computing apparatus having a memory; and
recording, in a database contained within the memory, the information and the document identifier.

11. The method of claim 10, wherein the communicating corresponds to the tag and is performed via the Internet.

12. The method of claim 10 wherein the web document corresponds to a second computing apparatus.

13. The method of claim 10 wherein the identifying information comprises an address, a name, a host, or a code.

14. The method of claim 10, comprising the additional step of creating a report of usage of the web document, wherein the report comprises the document identifier and information relating to at least one user.

15. The method of claim 10, comprising the additional step of creating a report of document usage, wherein the report comprises the document identifier and an analysis of a number of users of the web document at a point in time or in a time period.

16. A computer-readable carrier containing computer instructions that are capable of causing a computer to implement a method of monitoring user activities corresponding to at least one document, the instructions capable of causing the computer to perform steps including:
maintaining, on a first-computing apparatus, a document that is accessible via a global communication network, the document including a tag;
receiving information corresponding to a user of the document; and
delivering the information to a second computing apparatus.

17. A system for monitoring usage of a web document, comprising a processor programmed to perform the steps including:
maintaining, on a first computing apparatus, a web document having a document identifier;
receiving information relating to a user of the web document;
communicating the information relating to the user and the document identifier to a second computing apparatus having a memory; and
recording, in a database contained within the memory, the information and the document identifier.

18. A system for monitoring usage of a web document, comprising:
means for displaying a document on a first computer apparatus;
means, integral within the document, for receiving information corresponding to a user of the document; and
means for electronically transmitting said information to a second computer apparatus.
